(19) United States
(12) Patent Application Publication
(10) Pub. No.: US 2008/0118891 A1
(43) Pub. Date: May 22, 2008

(54) Contra-angle used for endodontology

(76) Inventor: Jean-Marie Badoz, Doubs (FR)

Correspondence Address: Gary M. Cohen, Esq.;Strafford Building Number Three, 125 Strafford Avenue, Suite 300, Wayne, PA, 19087-3318, US

(21) Appl. No.: 11/978,798

(22) Filed: Oct. 30, 2007

Related U.S. Application Data
(63) Continuation-in-part of application No. 10/567,166, filed on Feb. 3, 2006, now abandoned.

(30) Foreign Application Priority Data
Aug. 4, 2003 (FR) 03/09594

(51) Int. Cl. A61C 1/14; A61C 5/02

(52) U.S. Cl. 433/127; 433/102

(57) ABSTRACT

An endodontic contra-angle is provided with a head which supports an endodontic instrument having a shank and a blade. A connection associated with the head attaches the shank within the head of the contra-angle. The shank is permanently assembled within the body of the head, and is free to rotate within the head.

### RELATED CASE

This patent application is a continuation-in-part of prior co-pending U.S. patent application Ser. No. 10/567,166, filed Feb. 3, 2006.

### BACKGROUND OF THE INVENTION

The present invention relates to a handpiece or contra-angle used for endodontology.

Various instruments are known which can be used either to prepare or to bore tooth canals. Such instruments can be mechanized or manual, and can equally operate in continuous rotation or in reciprocating rotation. Rotational movement of the instrument is accomplished by the contra-angle handpiece on which the instrument is positioned.

Such instruments are generally provided with a shank, defined by the standard ISO 1797, for entering the head of the contra-angle. The head of the contra-angle is equipped with a mechanical device for removably attaching the instrument to the head.

For known instruments, the practitioner must always remove the instrument from the shank each time an operation to be performed is changed. This, in turn, increases the risk of prick injury and, therefore, the risk of contamination of the practitioner and the patient.

Furthermore, known devices for clamping the instrument onto the shank are bulky, which prevents small heads from being produced. This, in turn, restricts the visibility available to the practitioner.

### SUMMARY OF THE INVENTION

In accordance with the present invention, these various disadvantages are remedied by providing an endodontic handpiece that does not require a change of the instrument for each new operation which is to be performed.

To this end, an endodontic contra-angle is provided with a head for supporting an endodontic instrument, and an attachment for the connection of a shank associated with the instrument received in the head of the contra-angle. The shank of the instrument is permanently assembled to the body of the head, and is free to rotate within the head of the contra-angle.

Further description of the endodontic contra-angle of the present invention is provided with reference to the detailed description which is provided below, together with the following drawings.

### BRIEF DESCRIPTION OF THE DRAWINGS

FIG. 1 is a side elevational view of the endodontic contra-angle handpiece of the present invention.

FIG. 2 is an exploded, elevational view of the contra-angle handpiece shown in FIG. 1, showing the shank of the instrument withdrawn from the head.

FIG. 3 is a cross-sectional view of the contra-angle handpiece shown in FIG. 1.

FIGS. 4 and 5 are alternative embodiment, plan views of the contra-angle handpiece, showing different configurations for the shank-engaging connection.

### DETAILED DESCRIPTION OF PREFERRED EMBODIMENTS

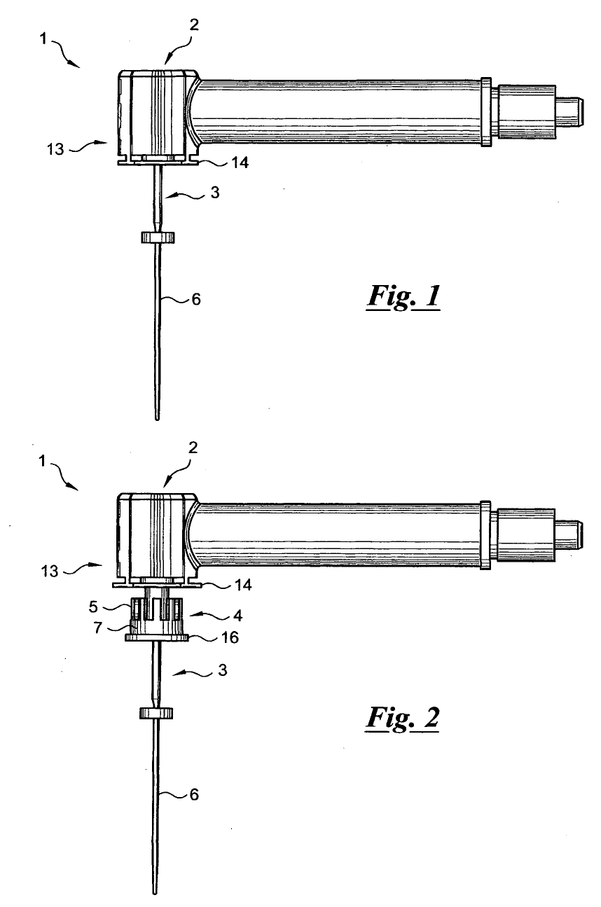

Referring to FIG. 1, the endodontic contra-angle handpiece 1 includes a head 2 which receives an instrument 3 for preparing, or boring, a canal. The instrument 3 can be any of a variety of instruments used for such purposes, responsive to the requirements of the practitioner.

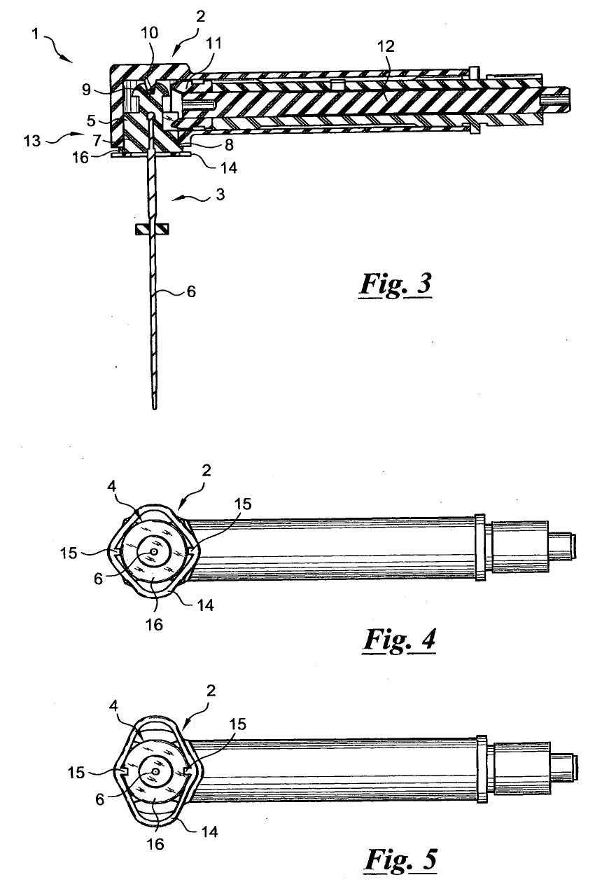

Referring to FIGS. 2 and 3, the instrument 3 has a shank 4 which includes a rotational drive 5, and a blade 6. The shank 4 of the instrument 3 cooperates with the head 2 of the contra-angle handpiece 1 for supporting the instrument 3 in the head 2, and includes a smooth surface portion 7 for cooperating with an opening 8 formed in the head 2 to promote rotation of the instrument 3, and a pivot 9 for cooperating with an axle 10 projecting from upper portions of the head 2 to promote rotation of the instrument 3 and to ensure a proper axial thrust of the instrument 3 in the upper portions of the head. The rotational drive 5 of the shank 4 of the instrument 3 cooperates with the output drive 11 of a drive shaft 12 which extends longitudinally through the contra-angle handpiece 1 to provide rotational movement for operating the instrument 3. A pinion preferably serves as the rotational drive 5.

The head 2 of the contra-angle handpiece 1 has a base 13 which is provided with a connection 14 for assembly of the shank 4 of the instrument 3 within the head 2 of the contra-angle handpiece 1. The connection 14 cooperates with the shank 4 of the instrument 3 to provide desired rotation of the instrument 3 and to permanently assemble the shank 4 of the instrument 3 and the head 2 of the contra-angle handpiece 1.

The contra-angle handpiece 1 is intended for only a single use, and is disposable. The contra-angle handpiece 1 is, therefore, preferably made entirely of a plastic material so that the overall cost of the contra-angle handpiece 1 is limited. The shank 4 of the instrument 3 is preferably made of a material that can be injection molded, such as a plastic, and the blade 6 that constitutes the working part of the instrument 3 is preferably made of steel, to further limit the overall costs associated with a contra-angle handpiece 1 which is intended for only one use. The blade 6 of the instrument 3 is advantageously overmolded by the shank 4 for fixing the blade 6 directly to the shank 4.

The connection 14 is axially aligned with the shank 4 of the instrument 3 and the pivot 9 which engages the axle 10 of the head 2 so that the shank 4 of the instrument 3 is free to rotate within the head 2 of the contra-angle handpiece 1, while permanently fixing the shank 4 of the instrument 3 to the head 2 of the contra-angle handpiece 1. The connection 14 forms a collar for engaging the shank 4 adjacent to the smooth surface portion 7, and for retaining the shank 4 within the head 2. In FIG. 4, the connection 14 is substantially rhombic-shaped, and in FIG. 5, the connection 14 is substantially oval-shaped.

A pair of fingers 15 projecting from the connection 14 preferably cooperate with a flange 16 formed on the shank 4, adjacent to the smooth surface portion 7, to assist in engagement between the shank 4 and the connection 14. In FIG. 4, the fingers 15 are positioned on opposing sides of the short diagonal of the rhombic-shaped opening, and in FIG. 5, the fingers 14 are positioned on opposing sides of the short axis of the oval-shaped opening.

The contra-angle handpiece 1 of the present invention exhibits an economic advantage in that the instrument 3 and the contra-angle 1 are made in such a way that the resulting assembly can be used only once. As a result, use of the contra-angle handpiece 1 will prevent contamination because the assembly is made disposable, eliminating the need for the practitioner to handle the instrument 3.

It will therefore be understood that various changes in the details, materials and arrangement of parts which have been herein described and illustrated in order to explain the nature of this invention may be made by those skilled in the art within the principle and scope of the invention as expressed in the following claims.

What is claimed is:

1. An endodontic contra-angle comprising:
a head for receiving an endodontic instrument so that the endodontic instrument is supported by the head, wherein the endodontic instrument includes a shank received by the head so that the shank penetrates the head of the contra-angle;
wherein the shank is pivotally associated with the head so that the instrument is free to rotate within the head, and wherein the shank includes a pinion cooperating with a drive shaft associated with the endodontic contra-angle, for rotation of the instrument, and a blade fixedly assembled on the pinion, wherein the pinion is overmolded onto the blade of the instrument; and
a connection for permanently assembling the shank of the instrument within the head of the contra-angle.

2. The endodontic contra-angle of claim 1 wherein the endodontic instrument is a canal instrument.

3. The endodontic contra-angle of claim 1 wherein the pinion is made of an injection-moldable material.

4. The endodontic contra-angle of claim 3 wherein the injection-moldable material is a plastic.

5. The endodontic contra-angle of claim 1 wherein the contra-angle is made entirely of plastic.

6. The endodontic contra-angle of claim 1 wherein the contra-angle operates with a reciprocating movement.

7. The endodontic contra-angle of claim 1 wherein the connection is axially aligned with the shank.

8. The endodontic contra-angle of claim 7 wherein the pinion is axially aligned with the connection and the shank.

9. The endodontic contra-angle of claim 7 wherein the shank includes a pivot engaging an axle associated with the head, and wherein the pivot and the axle are axially aligned with the connection and the shank.

10. The endodontic contra-angle of claim 1 wherein the connection is a collar which permanently engages adjacent portions of the shank within the head of the contra-angle.

11. The endodontic contra-angle of claim 10 wherein the shank further includes a flange located along the portions of the shank adjacent to the collar.

12. The endodontic contra-angle of claim 10 which further includes a pair of fingers positioned on and projecting from opposing sides of the collar.

13. The endodontic contra-angle of claim 12 wherein the shank further includes a flange located along the portions of the shank adjacent to the collar and cooperating with the fingers.
